(19) United States
(12) Patent Application Publication
(10) Pub. No.: US 2024/0202398 A1
(43) Pub. Date: Jun. 20, 2024

(54) BUILDING SYSTEM AND DESIGN AND ASSESSMENT THEREFOR

(71) Applicant: Shameran WARDA, Meadow Heights (AU)

(72) Inventor: Shameran WARDA, Meadow Heights (AU)

(21) Appl. No.: 18/547,043

(22) PCT Filed: Feb. 18, 2021
(86) PCT No.: PCT/AU2021/050139

§ 371 Date: Aug. 18, 2023

(51) Int. Cl. G06F 30/20; G06F 30/13; G06F 119/08; G06Q 50/08

(52) U.S. Cl. CPC G06F 30/20; G06F 30/13; G06Q 50/08; G06F 2119/08

(57) ABSTRACT

A building system with method of data gathering from various sources in various categories, data interaction providing enhanced search results and building characteristic management resulting in effective building, material product data and building characteristic values. Use of the data on defragmentation of a building design into subsets such as 71 to 84 and assessment of the individual subset and then the relative effect of one subset on adjacent subset so as to provide a whole effect of building characteristic values on the reconfigured building design and building construction.

### FIELD

The present invention relates to a building system in the design and selection of material for providing energy saving constructions and particularly a building characteristics assessment system and in particular to building heat transfer system for construction of buildings with various prefabricated building products.

The invention has been developed primarily for use in/with domestic buildings and will be described hereinafter with reference to this application. However, it will be appreciated that the invention is not limited to this particular field of use.

### BACKGROUND

The construction of a dwelling such as a house, is a combination of:
a) A building site and its environmental constituents
b) A design of house
c) An orientation of house and its location in its environment including
d) A selection of materials and
e) Building characteristics such as heat transfer and R value, moisture and moisture M value, cost and the V total value, and the daylight effects D of sun direction

However, the system of building at present is to design and build and while building choose materials by choice only and roughly in the categories as designed. The assessment of the energy savings is not undertaken until the end of the project. This is why one major approach for energy savings has been the use of air control so that a building is substantially sealed and thereby heat loss through air loss is reduced. The testing of the effectiveness of this system is after construction apply a large vacuum (negative pressure) and see where the leaks are located and the pressure loss rate to give a rating. This form of construct first and test later restricts the design and build of a house. It is suited to systems which can be enhanced after construction like sealing found leakage points. It is not suited to systems where choice of material or type of construction at the beginning or during building is required.

Therefore at present you are reliant on the skill and experience and coordination of your architect, designer, builder and project manager to generally aim for a result which is not determined until after construction.

The heat transfer of a building, as one building characteristic that is checked at the end of a project and corrected then if possible, is usually a combination of primary heat transport modes including:
Conduction (heat flow on a molecular scale. Medium at rest or moving);
Convection (heat conveyed as internal thermal energy of mass that is displaced by mean or turbulent motion);
Radiation (heat transfer by electromagnetic waves such as infrared or visible light).

In buildings, heat is also transported by the following mechanisms, which basically belong to the convection mode:
Transfer of latent heat by transport of water or water vapor.
Thermal energy associated with the air replaced in a building by ventilation or by air leakage (infiltration).
Thermal energy associated with fresh and used domestic water and combustion air (including flue gases), and fluids feeding Heat Pumps.

It can therefore be seen that often the heat transfer is determined by the airflows and the heating and cooling sources and airflow from these sources.

However, another important element, which basically belongs to the radiation mode is the heat transfer through materials such as the structure of walls, windows, doors etc. This transfer through an interface can be calculated when it is a homogenous medium. However, most are complex structures formed of a plurality of different substrates. These can come with instructions of how the substrates are to be placed together or they more often are being provided in a prefabricated form with all of the substrates already joined into one complex product. Often then it is not possible to calculate the heat transfer through the product but instead an experimental determination is required.

The present approach to heat transfer is to obtain a rating after construction. Therefore a building is designed by an architect with best practices but not to the detail of which product or which type of windows or the final internal designs. Even some external walls might be selectively of different materials dependent on the choice of the building purchaser. There is an expected heat transfer rating based on an expected material heat transfer. However in construction there is also often changes and final selections of material or size of windows or coverings etc and the final construction is different to the original design and substantially different to the expected heat transfer calculation.

Another problem is that manufacturers are constantly changing product details due to variation of elements in a complex substrate, or due to availability of component parts, or due to variation for cost purposes. This results in catalogues or product sheets being outdated often or just being incorrect or being an expected average. This causes problems to the builder or designer as they would have to follow up on all possible variations and review and obtain latest details of all possible components of the building. At present this is avoided by merely undertaking the heat transfer review the time of completion of the building. However by that time the decisions have been made without proper consideration of the heat transfer and how a better selection could have resulted in a better result.

As can be seen, there is a need for a method and system for improving heat transfer management and building design integration.

It can be seen that known prior art building heat transfer systems have the problems of:
a) Not being available before or during construction
b) Not allowing feedback on selections
c) Not allowing for complex substrate products
d) Not being accurate at the time unless left until after construction finished
e) Not aiding design choices
f) Not showing benefits or deficits of design choices

The present invention seeks to provide a building heat transfer system, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

According to a first aspect of the present invention, there is provided a building heat transfer system enabling efficient construction of a building including
a) A modelling module for receiving a design of a building and defining a model of the building;
b) A defragmentation module which dissects the building design into building subsets with building substrates;
c) A building location module which receives input of building location characteristics and reviews building subsets and determines the impact of heat transfer on building subsets;
d) A heat transfer module which reviews building substrates, building design and building location characteristics of building subsets to calculate heat transfer of each building subset; and
e) A reconfiguration module which reconfigures the building subsets to reconfigure the model of the building and determines the effect of heat transfer of one subset on another to determine heat transfer of the entire building.

The building heat transfer system can further include
a) a communications module for cotemporaneous communication connection to a plurality of product suppliers at the time of review to obtain in real time the heat transfer of a product forming a building substrate.

Preferably the building heat transfer system further includes:
a) a selection module which provides a selection of building products to be used to form building substrates and receives input of selection of a product from a connected source of a range of products for a defragmented building substrate;
b) a communications module for cotemporaneous communication connection to the plurality of product suppliers at the time of selection to obtain in real time the heat transfer of a product forming a building substrate

Also the building heat transfer system can further include
a) a what-if comparator module which receives the heat transfer of the entire building
b) record of the model reconfiguration of building subsets
c) tracking of the selected building products and the received contemporaneous heat transfer of the selected building products)
d) recording of the reconfiguration of building subsets resulting from selection
e) and displaying of the effect of the selected building products in the model to show the effect of the selection to enable efficient construction and energy efficient heat transfer for the entire building.

It can be seen that the invention of building heat transfer system provides the benefit of:
i) Improvements in users seeing in real time the heat transfer effects of their selection of product variations or product selection or design variation;
ii) The efficient building to required heat transfer ratings by real time reconfiguration of heat transfer subsets;
iii) The real time feedback of the real characteristics of actual selected substrates and not average or expected rating;

In another aspect of the present invention can be a method for improving a building modelling system for a building including coupling a product selection functionality to the building modelling system; the product selection functionality adapted to: provide building characteristic data relating to the building modelling system, wherein building characteristic data is associated with resolution of a selection of the building modelling system; provide a heat transfer rating configured to a first product for both a delivery of the building characteristic data and a second product for an associated resolution to the building characteristic data; and provide a progress heat transfer rating configured to link field data from a jobsite of the building to the building characteristic data.

In another aspect of the present invention can be the method for improving a building modelling system for a building includes coupling a product selection functionality to the building modelling system; the product selection functionality adapted to: obtain virtual building characteristic data relating to the building modelling system, wherein building characteristic data is associated with resolution of a selection of the building modelling system, and wherein building characteristic data includes at least one product required for the associated resolution, wherein each product comprises fitting data and location data, wherein fitting and location data is defined by the building modelling system; provide a heat transfer rating configured to a first product for both a delivery of the building characteristic data and a second product for an associated resolution to the building characteristic data, wherein field data comprises video, audio and textual output linked to the first or second product; and provide a progress heat transfer rating configured to link field data from a jobsite of the building to the building characteristic data; and a resolution functionality configured to generate construction data linked to the first or second product, wherein construction data comprises video or audio output from the jobsite.

These and other features, aspects and advantages of the present invention will become better understood with reference to the following drawings, description, and claims.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic view of a homogenous material forming a building panel for use in domestic building for building heat transfer system enabling efficient construction of a building in accordance with a preferred embodiment of the present invention; and

FIG. 2 is a diagrammatic view of different complex building substrates for use in the system of FIG. 1;

FIGS. 3, 4 and 5 are diagrammatic views of a building subset, plurality of building subsets and interlinking building subsets respectively of system for heat transfer for a domestic building in accordance with another preferred embodiment of the present invention;

FIG. 6 is a diagrammatic view of a real plan divided into plurality of building subsets and interlinking building subsets respectively of system for heat transfer for a domestic building in accordance with another preferred embodiment of the present invention;

FIG. 7 is a diagrammatic view of a total building formed of the subsets;

FIG. 8 is a diagrammatic view of an elevation of the total building showing site orientation and its effect on building subsets due to weather considerations such as angle and pathway of sun;

FIG. 9 is a diagrammatic view of the functional interrelationship of external sources of material and upload of particular online product module of particular constructional elements or components for selection in designing and assessing with real time values.

FIG. 10 is a diagrammatic view of a particular online product module and an embodiment of a means of transporting such online product module by QR code for use in method for improving a building modelling system;

FIG. 11 is a diagrammatic view of a particular online product module and an embodiment of a means of transporting such online product module by QR code for use in method for improving a building modelling system;

FIG. 12 is a diagrammatic view of a screenshot enabling the functional interrelationship of external sources of material and upload of particular online product module of FIG. 9

FIG. 13 includes a defragmentation of the building module as per FIGS. 1 to 4 for progression to build and assess each module before reconfiguration and total design and assessment;

FIG. 14 includes a defragmentation of the building module as per FIGS. 1 to 4 for progression to build and assess each module before reconfiguration and total design and assessment;

FIG. 15 is an operative diagrammatic screenshot showing selection of different materials on defragmented modules of entire building showing online connections with particular online product modules and real time assessment;

FIG. 16 is an operative diagrammatic screenshot showing selection of different materials on defragmented modules of entire building showing online connections with particular online product modules and real time assessment;

FIG. 17 is an operative diagrammatic screenshot showing selection of different materials on defragmented modules of entire building showing online connections with particular online product modules and real time assessment;

FIG. 18 is a variation of FIGS. 15, 16 and 17 in which there is operative screenshot of a split tool for applying different materials on only part of a defragmented module of entire building showing online connections with particular online product modules and real time assessment;

FIG. 19 is a diagrammatic view of a report showing final selections, assessment, design and values of the final design;

FIG. 20 is a diagrammatic flow diagram of the operation of the building heat transfer system enabling efficient construction of a building in accordance with a preferred embodiment of the present invention;

FIG. 21 is a diagrammatic flow diagram of the operation of the building heat transfer system enabling efficient construction of a building in accordance with a preferred embodiment of the present invention;

FIG. 22 is a diagrammatic flow diagram of the operation of the building heat transfer system enabling efficient construction of a building in accordance with a preferred embodiment of the present invention;

FIG. 23 is a diagrammatic flow diagram of the operation of the building heat transfer system enabling efficient construction of a building in accordance with a preferred embodiment of the present invention;

FIG. 24 is a diagrammatic flow diagram of the operation of the building heat transfer system enabling efficient construction of a building in accordance with a preferred embodiment of the present invention;

FIG. 25 is a diagrammatic view of the components for operation of the building heat transfer system enabling efficient construction of a building in accordance with a preferred embodiment of the present invention;

FIG. 26 is a diagrammatic view of the components for operation of the building heat transfer system enabling efficient construction of a building in accordance with a preferred embodiment of the present invention;

FIG. 27 is a diagrammatic view of the components for operation of the building heat transfer system enabling efficient construction of a building in accordance with a preferred embodiment of the present invention;

FIG. 28 is a diagrammatic view of the components for operation of the building heat transfer system enabling efficient construction of a building in accordance with a preferred embodiment of the present invention;

FIG. 29 is a diagrammatic view of a comparative review as one output of the operation of the building heat transfer system enabling efficient construction of a building in accordance with a preferred embodiment of the present invention; and

FIG. 30 is a diagrammatic view of the interaction of the components for the operation of the building heat transfer system enabling efficient construction of a building in accordance with a preferred embodiment of the present invention.

### DETAILED DESCRIPTION OF EMBODIMENTS

It should be noted in the following description that like or the same reference numerals in different embodiments denote the same or similar features.

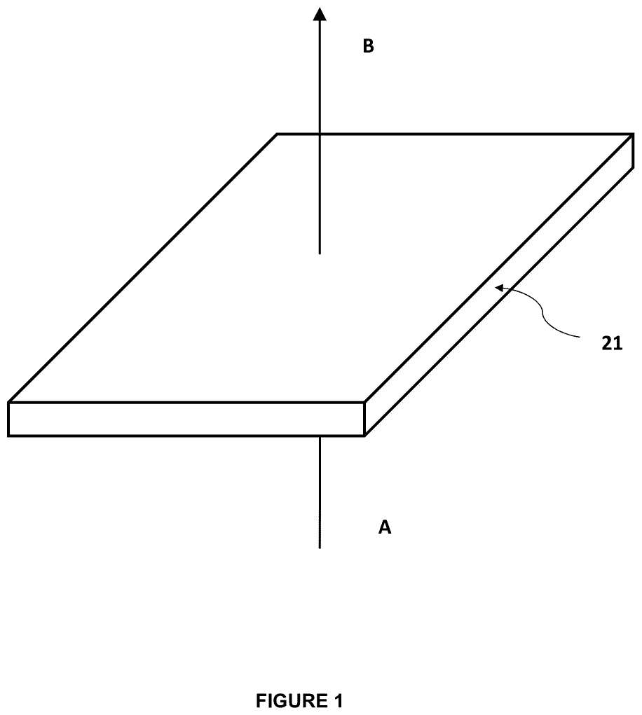

Referring to the drawings and particularly FIGS. 1 to 8 there is shown domestic buildings

FIG. 1 shows a simple building panel formed of a homogenous material forming a building panel for use in domestic building for building heat transfer system enabling efficient construction of a building in accordance with a preferred embodiment of the present invention. There is a building characteristic of heat value of R of heat transfer from A to B.

However even with simple panels the construction can include different cavity sizes between panels. Therefore, quite quickly, the simple panel becomes a complex substrate when it also includes an insulation layer in the cavity.

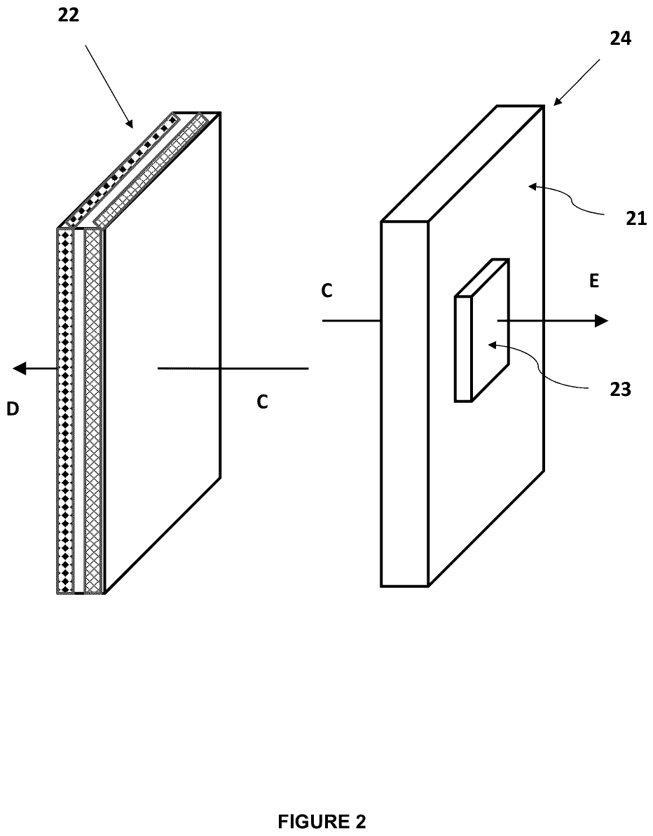

Complex building substrates 22, 24 such as shown in FIG. 2 is indicative of the need to consider not only different materials, but different sizes, different thicknesses, different designs, different composites layers etc. In FIG. 2 the building substrate 22 has a heat transfer C to D caused by the different components of the different composites layers of the substrate. This heat transfer is different to the complex substrate 24 on an opposing wall such that the heat transfer could be modified by the inclusion of a window 23 providing a heat transfer C to E that will affect the whole substrate depending on the relative quantities of wall 21 to window 23. Therefore, the complex substrates can have a heat transfer value R.

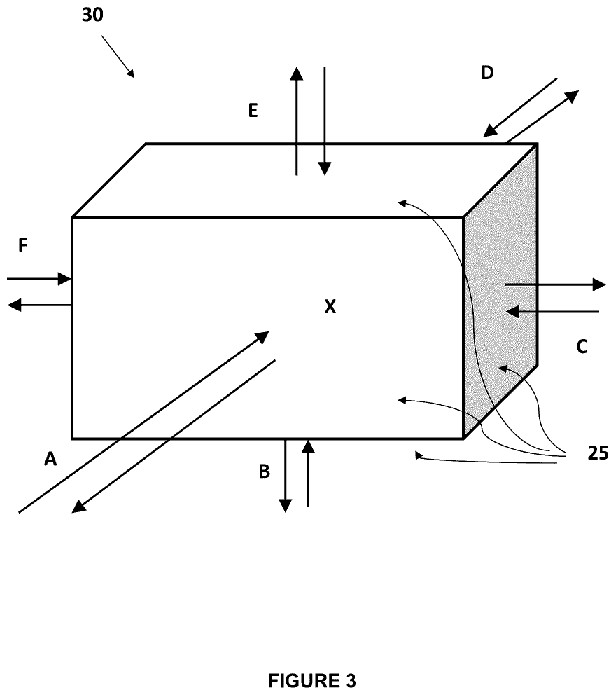

FIGS. 3, 4 and 5 are diagrammatic views of a building subset 30, plurality 40 of building subsets 31 to 35 and interlinking building subsets 41 respectively of system for heat transfer for a domestic building in accordance with another preferred embodiment of the present invention.

In FIG. 3 it can be seen that a building subset 30 has a heat transfer comprising of inwards from all sides A, B, C, D, E, F, to inner volume X as well as heat transfer comprising of outwards from inner volume X through all sides A, B, C, D, E, F. This results in the need to determine AX, BX, CX, DX, EX, FX, as well as XA, XB, XC, XD, XE, XF. Clearly in inert situations there will be a simple one-way heat effect. However, when there are heat sources, whether internal or from weather effects, the effect can be in both directions and can change at different times and needs to be considered.

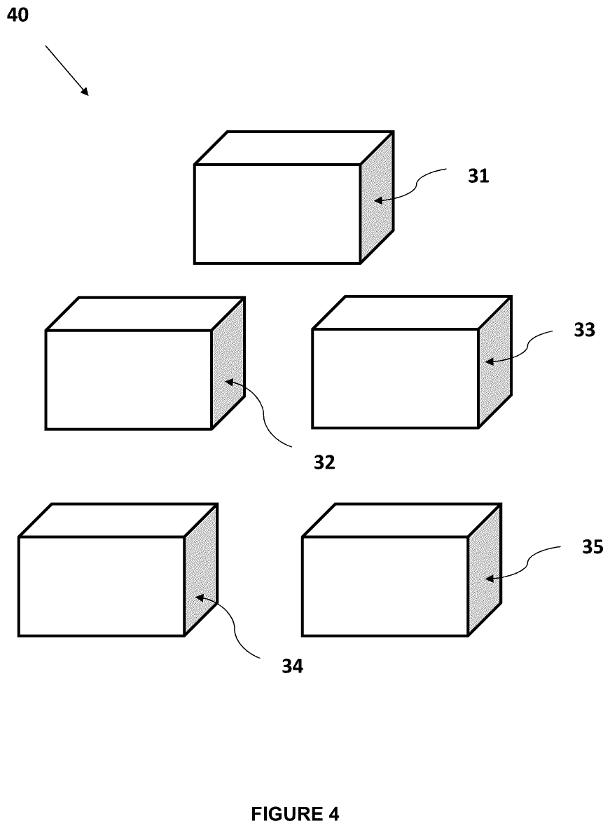

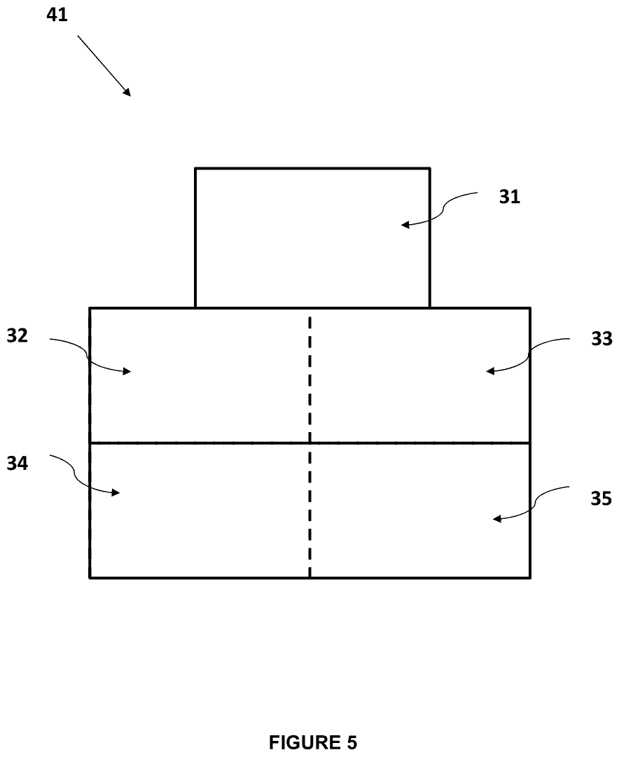

FIGS. 4 and 5 show that the subsets 31 to 35 can be separately assessed and then relatively assessed in particular relative effect as 41 in FIG. 5 by their relative effect on each other. Therefore, there can be the effect of a heater or other heat source like a window to direct sunlight in subset 31. This can be assessed for the subset 31 as in the separate subsets 40 of FIG. 4. However as shown in the related subsets 41 of FIG. 5 the heat in subset 31 will affect the attached subsets 32 and 33 and therefore the heat transfer determinations for those subsets will need to consider the effect of the adjacent subset 31.

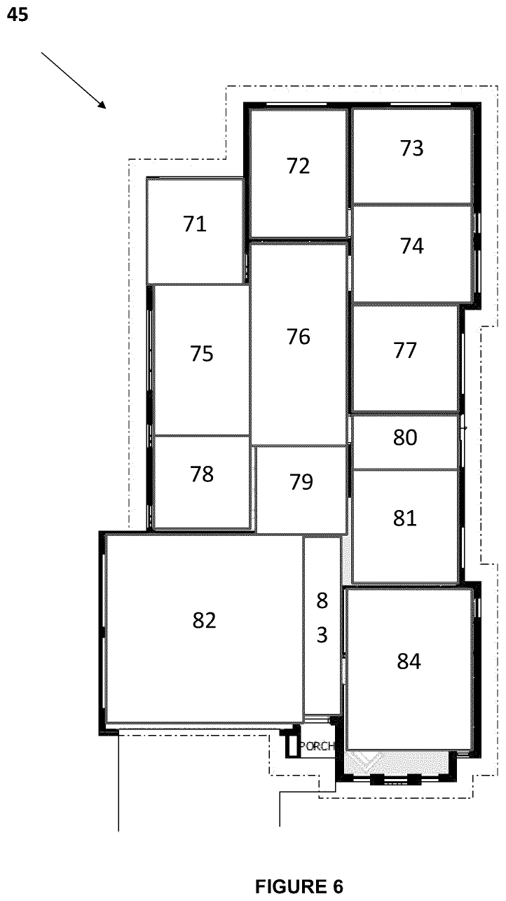

FIG. 6 is a diagrammatic view of a real building plan 45 divided into plurality of building subsets 71 to 84 and interlinking building subsets respectively of system for heat transfer for a domestic building in accordance with another preferred embodiment of the present invention.

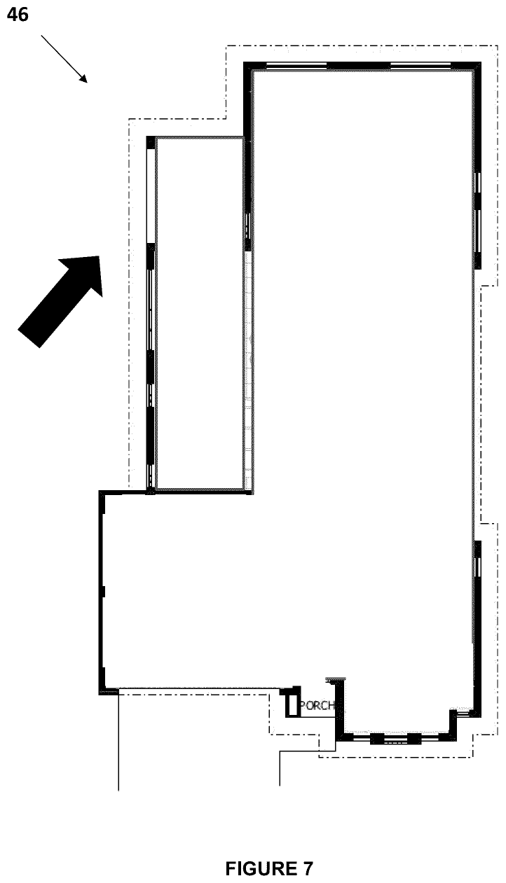

FIG. 7 is a diagrammatic view of a total building 46 formed of the subsets. This is a practical way that the floorplan of a house needs to be fragmented into individual subsets 71 to 84 so that the heat transfer of each subset can be used to determine the heat transfer of total building 46 formed of the subsets

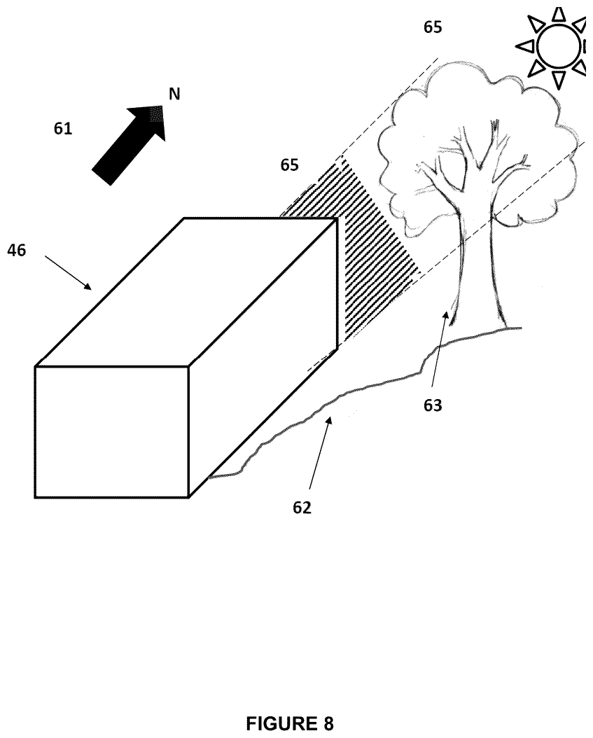

FIG. 8 is a diagrammatic view of the total building 46 showing site orientation 51 and its effect on building subsets due to weather considerations such as angle and pathway of sun and the shadow caused by the topography 52 or the trees 53. The heat transfer within the building system can be reviewed with reference to the heat transfer through internal building subset of the building system and the heat transfer through peripheral building subset of the building system and the heat transfer through window, door or opening of the building system and the heat transfer through roofing building subset of the building system.

The following detailed description is of the best currently contemplated modes of carrying out exemplary embodiments of the invention. The description is not to be taken in a limiting sense but is made merely for the purpose of illustrating the general principles of the present invention.

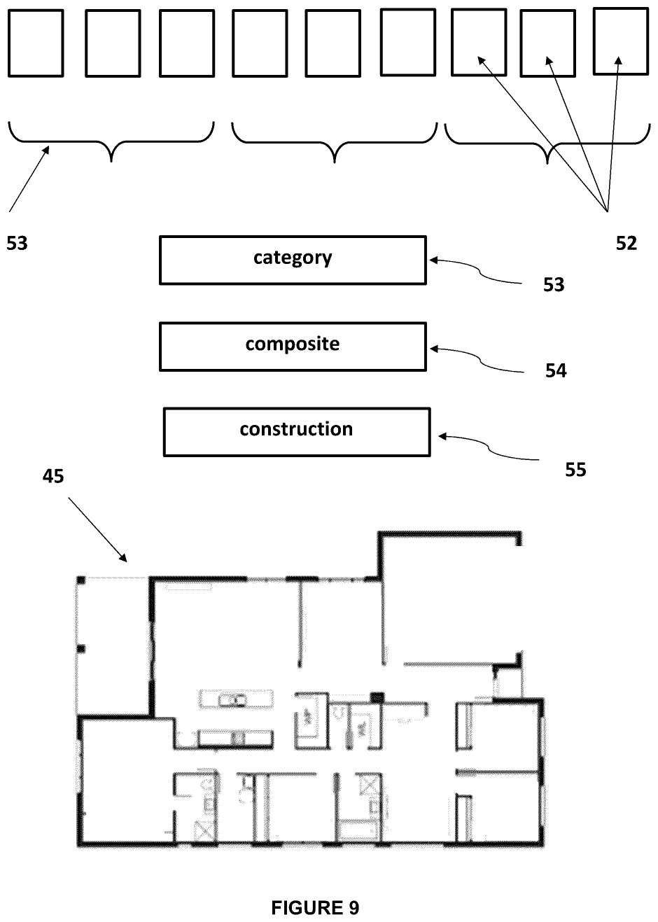

Referring to FIG. 9 the present invention relates to method of data gathering from various sources 52 in various categories 53, integrating the data including and providing analytics that improves data management, data availability, data interaction providing enhanced search results and building characteristic management resulting is faster decision making, data and time related forensics. The present invention is cloud-based system combining applications and algorithm, virtual data gathering and management, real data gathering and management and analytics of all such isolated data in a more interlinked data structure.

However the data cannot be merely inserted. Instead there must be the defragmentation of a building design 45 into subsets such as 71 to 84 of FIG. 6 and assessment of the individual subset and then the relative effect of one subset on adjacent subset so as to provide a whole effect on the reconfigured building design 45.

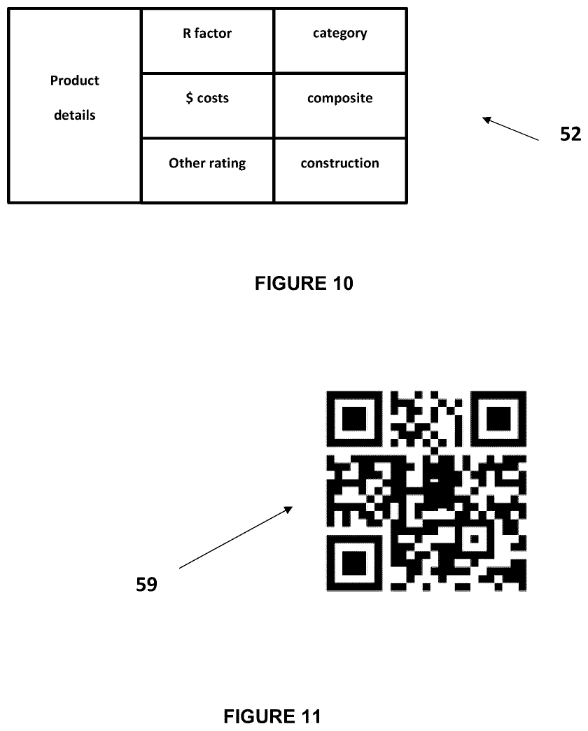

The method of data gathering is the use of an online product module such as shown in FIG. 10. There can be a number of ways of collecting the data. This can include:
a) Downloadable online product module 52 from online site of supplier with formatted building characteristic values and inclusive of latest up to date information including material, building material and building construction and building characteristic values;
b) Connecting module attachable to the websites of the online site of supplier that is bespoke to each of the suppliers 111, 112, 113, 114 to create a respective online product module 52 for download to the communication module 95 for providing the information for use in the building characteristic assessment module 93.
c) Connecting to the websites of the online sites of suppliers 111, 112, 113, 114 and downloading information which is transformed to create an online product module 52 for download to the communication module 95 for providing the information for use in the building characteristic assessment module 93

Referring to FIGS. 10 and 11 there is a particular online product module 52 and an embodiment of a means of transposing such online product module by QR code 59 for use in method for improving a building modelling system. To undertake use of the QR code the upload app undertakes the steps of:
a) Open the upload app from the Home screen, Control Centre or Lock screen.
b) Select the rear facing camera. Hold your device so that the QR code appears in the viewfinder in the upload app. Your device recognises the QR code and shows a notification.
c) Tap the notification to open the link associated with the QR code.

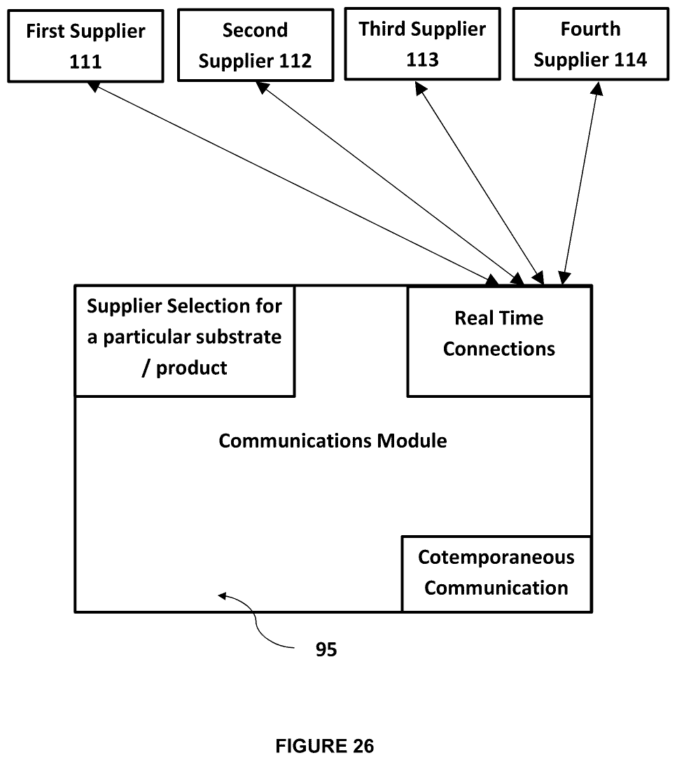

Referring to FIG. 26 there is a communication module 95 that interacts with the online presence of various suppliers 111, 112, 113, 114. This can be real time connections so as

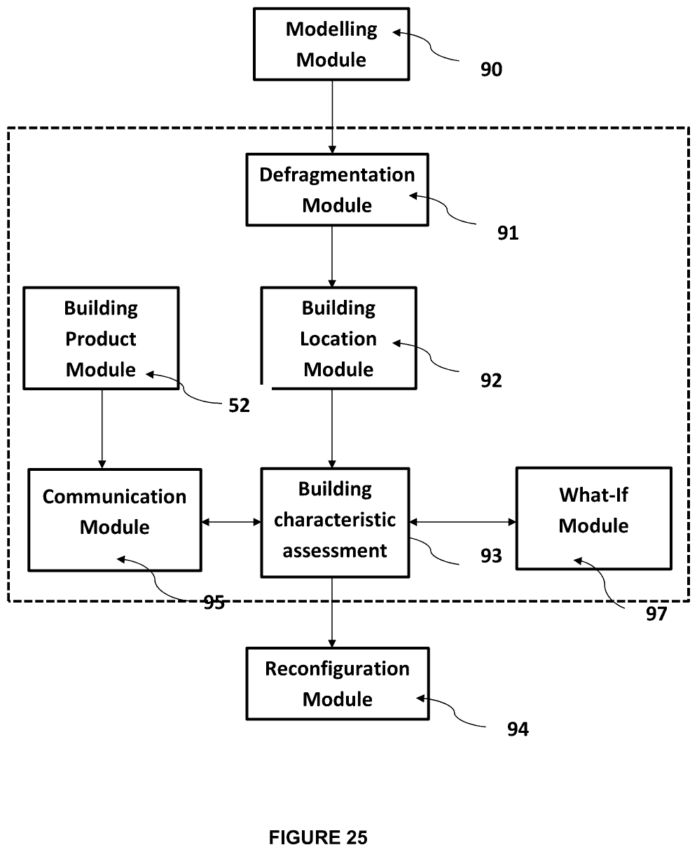

Referring now to FIG. 25, the present invention includes network of at least one computer with a user interface and communication systems. The computers can include at least one processing unit, a plurality of processing modules. The computer includes a program building subset including a machine-readable program code for causing, when executed, the computer to perform steps. The program building subset may include software which may either be loaded onto the computer or accessed by the computer. The loaded software may include an application on a smart device. The software can be accessed by the computer using a web browser. The computer may access the software via the web browser using the internet, extranet, intranet, host server, internet cloud and the like.

The present invention can be adapted to provide back-end analytics and algorithms that compares current and historic effects on other building characteristics for similarly situated content or building characteristic data, facilitating the generation of auto alerts and reports informing required parties of potential issues, whereby building characteristic teams can be proactively notified, allowing them to create proactive measures and avoid potential issues that can cause delays, cost overruns or create unsafe environments when resolving heat transfer variations.

The present invention may enable integration and splitting of existing heat transfer models. Furthermore, the present invention can be adapted to provide material and construction data and integrated building models.

The system embodied by the present invention can be adapted to facilitate automation in live (in real time) assessing and designing modes.

A method of using the present invention may include the user creating a building and fill in all identifying attributes of said building characteristic, such as building characteristic name, building characteristic type, supplier number, proposed start date, and the like. Each building characteristic can be assigned a unique user ID and password, whereby the associated user may manage said building characteristic as an ‘administrator’ using said user ID and password. The present invention can be adapted to validate or otherwise impose restrictions on administrators.

The present invention can be adapted to prompt the administrator to divide a building characteristic (or building model) into a plurality of levels, sections or building subsets, through creating and selecting the given building characteristic. Such building subsets can be imported (or exported) from other building characteristics or templates. Each subset can be populated with building components.

The present invention may provide a window in the computer interface that generates a variation file capable of detecting and representatively identifying physical variations between various components within the building model as well as between associated building subsets, such as between insulation components and fireproofing components. Such variation file can be retrievably stored in a database along with a plurality of variation files. Each variation file may provide variation details imported through various formats, including but not limited to audio, visual and electronic files. Each variation file can be associated with a trade of a supplier, for example windows, building components, insulation, etc. The variation files can be sorted by each variation detail, such as status, associated suppliers, and the like.

### A ‘Heat Transfer’ Component

The present invention relates in one embodiment, but preferably as part of a complex embodiment, to one building characteristic of managing heat transfer, collated heat transfer resolutions and improving heat transfer building characteristic management. Although, heat transfer provides advantages to constructions, it continues to struggle with providing the right solutions at the real time of building.

The current solution, or lack of one, leaves the users and managers with abundant data to sort through, examine and then determine which data to assign downstream to modify the data to solve the issue. This is not only a cumbersome approach but it sometime creates changes undermining the building subset. Also, more importantly, the lack of better tracking and reporting of issue in timely fashion exposes the building characteristic to delays or last-minute crises.

The heat transfer system of the present invention is a platform, tool, system and a method that enables heat transfer managers to efficiently manage the data, users and virtual issues in a structured format allowing improved workflow downstream to data authors and reporting analytics for mangers to take proactive decisions potentially increasing building subset and reducing risk for building characteristics.

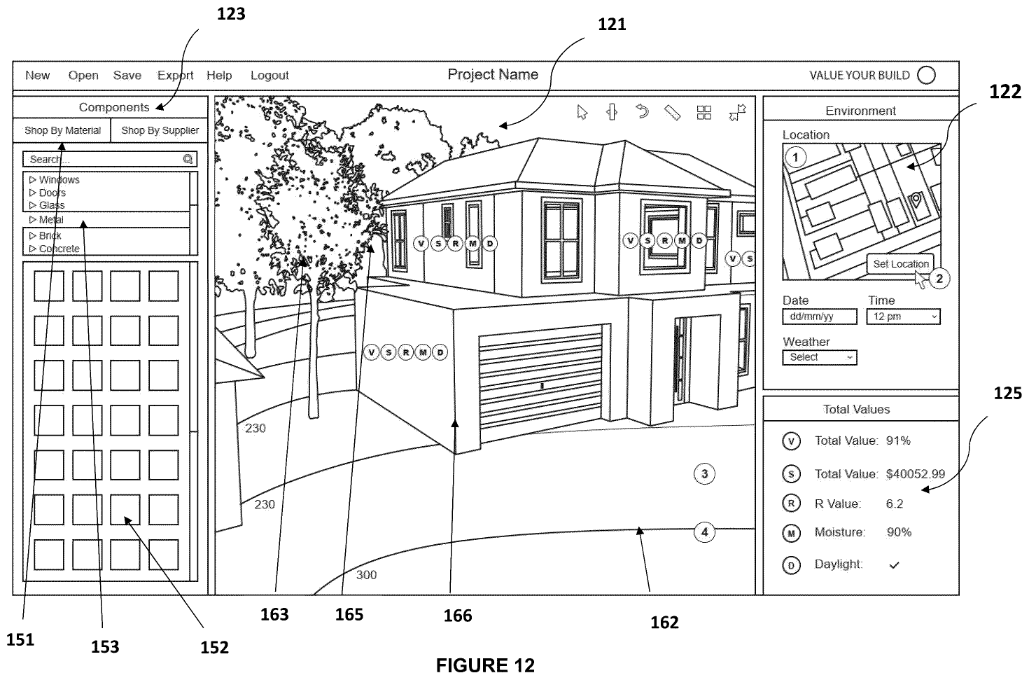

FIG. 12 is a diagrammatic view of a screenshot enabling the functional interrelationship of external sources of material and upload of particular online product module

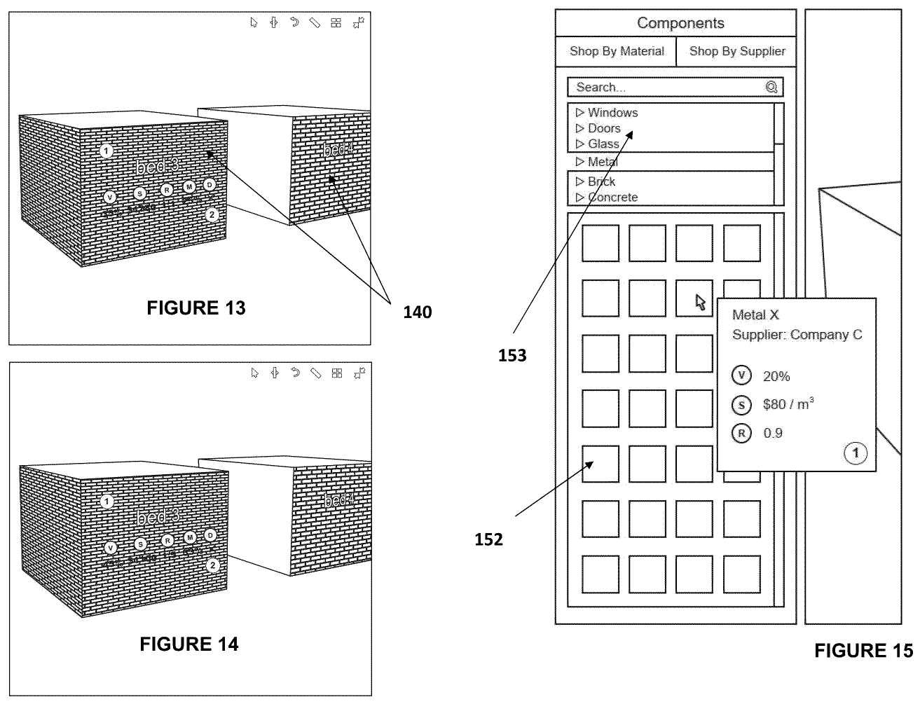

As shown in FIGS. 13, and 14 there is included a defragmentation module and display of the building module and subset as per FIGS. 1 to 4 for progression to build and assess each module before reconfiguration and total design and assessment.

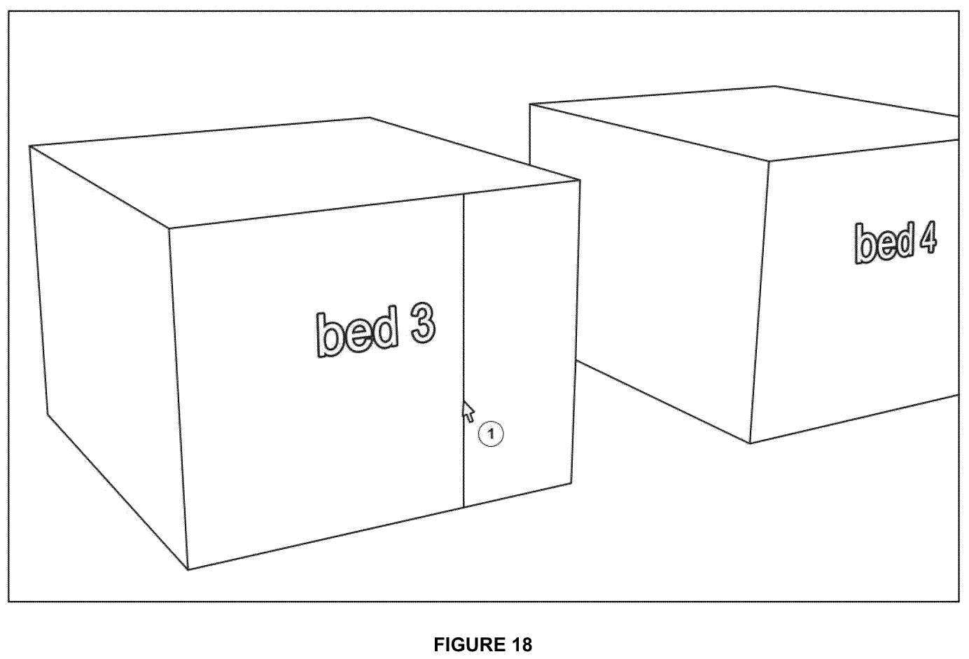

FIGS. 15, 16 and 17 are operative diagrammatic screenshots showing selection of different materials on defragmented modules of entire building showing online connections with particular online product modules and real time assessment. FIG. 18 is a variation of FIGS. 15, 16 and 17 in which there is operative screenshot of a split tool for applying different materials on only part of a defragmented module of entire building showing online connections with particular online product modules and real time assessment;

Referring to FIG. 12 there is a diagrammatic screenshot of an API. The screenshot comprises central panel 121 showing house design in 3D diagrammatic, location panel 122, workspace 123 for effecting communication module , selection module and online product module, and output 125 of values of building characteristics.

There is a
a) connection to a Google Maps API. This is a small window where the Google Maps API is used. This allows the user to search for a location on the map 122 and left click to drop a pin on the map.
b) A Set Location Button is provided so that Clicking this button sets the location of the model to the location pinned in the maps window above. This allows the model to simulate the chosen location.
c) The central panel includes the 3D from the design 46 by Import 2D floorplan or 3D Model 166. Users are provided the option to import a 2D floorplan such as shown in FIG. 5, 6 or 7 to build a project from or with this option the user is able to import a 3D model built using external tools. A draw tool allows the user to draw over the imported floorplan and expand it into a simple 3D model to be used.
d) Central panel also includes orientation of the house, the topography by topographical lines 162, the environment including direction of North, direction of sun, tress 163 shadows 165 on the building 166
e) Workspace 123 is the window where users will import and interact with building models and materials. The workspace is blank before a project is imported or opened.
f) Components tab is the tab users may shop for materials to add to their project, filtering them by supplier or by material type. This can include categories such as brick, windows, doors, tiles, composite wall panels, wall finishes, floor material, insulation etc.
g) An Environmental Model which provides a simulation of the environment at the selected location is added to the project model. Allows the user to find and set a location for the project as well as alter the date, time, and weather to simulate changes to the project's environment.
h) Topography Lines providing Representations of topographical data gathered from the Maps API
i) Total Values which is The total values tab is updated in real time to reflect the effects of the chosen location's environment, topography and climate. Displays the V total value, $ total cost, total R value, total moisture M value, and the state of daylight D requirements for the current project. These values are continuously updated as the user makes changes.

FIGS. 13, and 14 include a defragmentation of the building module 166 as per FIGS. 1 to 4 into plurality 140 of building subsets for progression to build and assess each module before reconfiguration and total design and assessment.

The display of FIG. 12 includes a display which shows the online connected contacts 152 such as shown in FIG. 9 where there can be a product module uploaded for inclusion in the design and assessment and valuing as shown in FIG. 15 in which the app includes
a) Shop by Material Filter which displays materials in the Components tab 153, grouped by material type
b) Search Bar which allows the user to search for a specific material or material type, which is then displayed in the material selection window
c) Material Type List which provides users with a list of material types to select from, displaying materials of the selected type in the window below.
d) Material Selection in which there is uploaded a list of materials of the type selected in the material type list, displayed in a grid of unique names and icons. The user may drag and drop materials from this list to apply them to the model in the workspace.

The display in the app further includes
e) Shop By Supplier Filter 152 which displays materials in the Components tab, grouped by their supplier.
f) Supplier List which is a list of suppliers for the user to select from, displaying materials provided by the selected supplier in the window below.
g) Material Selection which is a list of materials provided by the selected supplier in the supplier list above, displayed in a grid of unique names and icons. The user may drag and drop materials from this list to apply them to the model in the Workspace.
h) Surface Selection in which users are able to left click on a surface of the model in the workspace to select it, highlighting the surface and opening a popup window where they can add or adjust dimensions. The user may also hold shift+click to select multiple surfaces

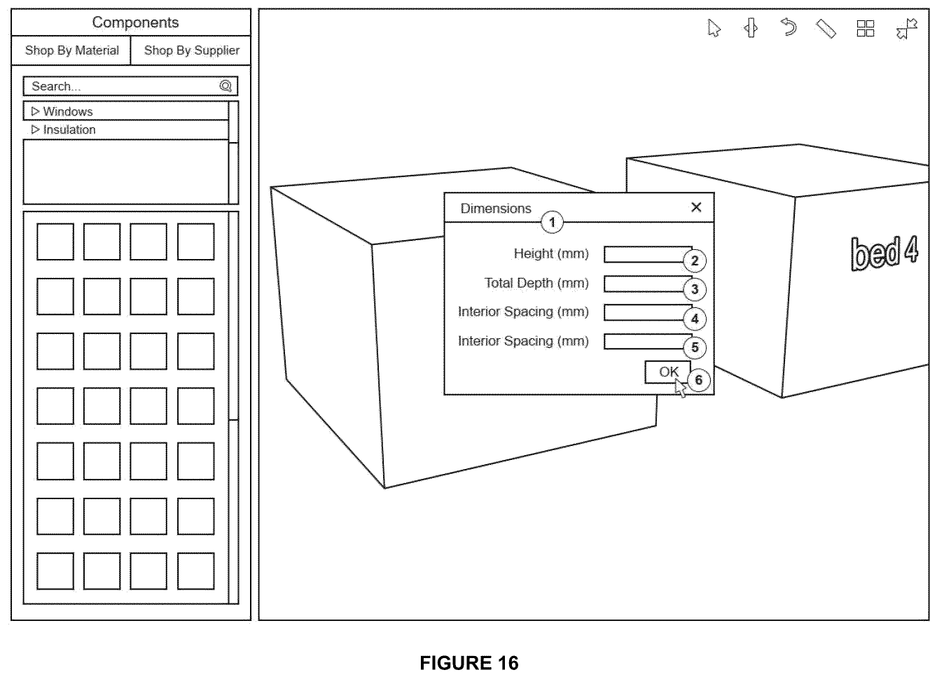

FIG. 16 shows the configuration of the elements of the defragmented module in which a dimension tool is provided by a small popup window created when users select a surface in the workspace, allowing users to add or adjust the dimensions of the selected surface. This includes:
i) Height Field which allows users to enter a height (in mm) for the selected surface
j) Total Depth Field which allows the user to enter a depth (in mm) for the selected surface. The total depth entered must be greater than the interior+exterior spacing of the selection.
k) Interior Spacing Field which allows users to enter interior spacing (in mm) for the selected surface.
I) Exterior Spacing Field which allows users to enter exterior spacing (in mm) for the selected surface.
m) OK Button which confirms the additions or changes made in the above fields, closing the dimensions window.

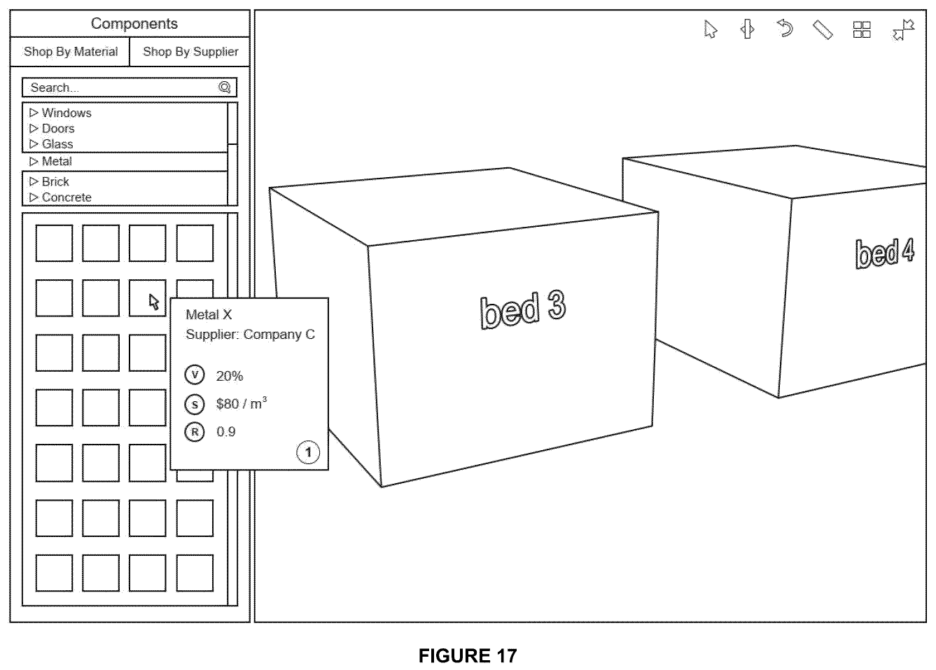

FIG. 17 shows the product display material tooltip in which Tooltip that appears when the cursor hovers over a material in the materials selection. This tooltip displays the name and supplier of the hovered material as well as its individual value, cost (per m2), and R value.

A Drag+Drop New Material tool enables after having dragged a material from the materials grid, users can release the left mouse button to drop selected material and apply it to the chosen surface. Right click will cancel the process and drop the material without applying it to the model. A new value tooltip will appears when the cursor hovers over a surface while holding a material. The tooltip shows the user the new values of the selected room if the material is applied.

An updated model in the workspace reflects the changes made by the user after a material is applied and will show:
a) Applied Materials of the updated material
b) Room Values of the updated value, cost, R value, moisture value, and daylight requirements of the room are clearly displayed on the model.
c) Total Values which effects the total values tab to be updated in real time to reflect the changes made by the user

FIG. 18 shows the use of a split tool which is used to split a surface into multiple selectable parts, allowing the user to adjust and apply different materials to sections of the same surface. Users may do this by left clicking the split tool at the top of the workspace, then clicking and dragging along a surface of the model. This will create a horizontal or vertical line that acts as a boundary for each of the new selectable sections on either side of it. The structural framing is another material that can affect the R-values. For example, timber framing of the whole building adds an additional affect as a standalone material and as a whole system: to walls, ceiling, roof construction systems etc.

The software will have tools to add thickness, height, cavity, insulation, air gaps etc to all construction systems.

Another reason why material selection is important is that you want to select the best material choice to reduce heat coming into the building in summer and vice versa, in winter you want the heat to be kept inside. Selection of Insulation will aid in the construction system along with material selection, taking into consideration the moisture affects, environmental characteristics etc.

Wall System sketch—The drawing of the wall system is representing a section of how to construct and build up the wall system. This can also been done in a reversed manner where you already have your 3d model and architectural drawing and can be applied by adding height, depth, interior/exterior spacing.

### Report Component

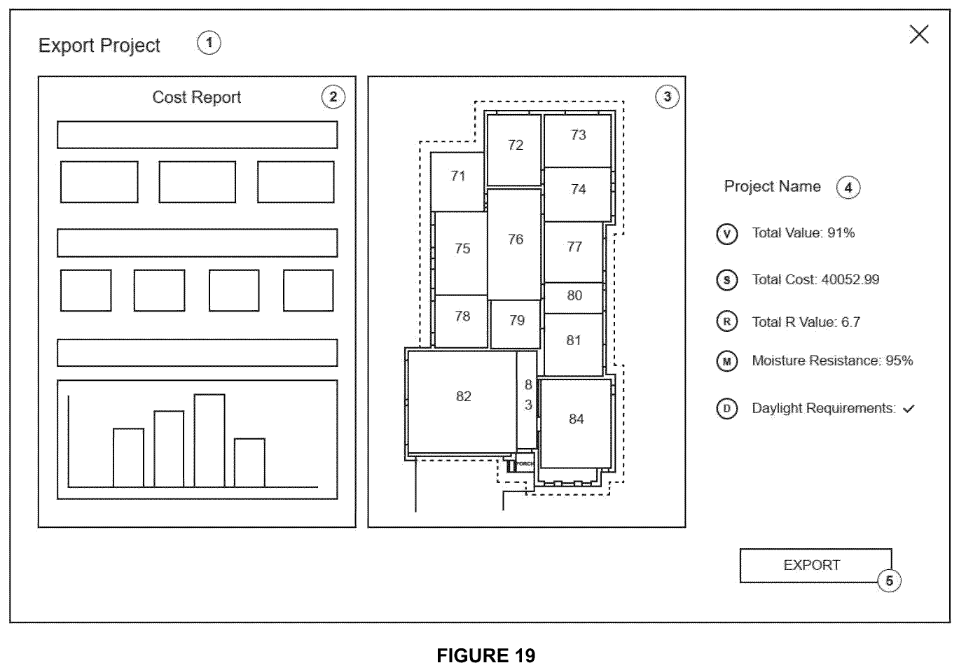

Referring to FIG. 19 there is the report. The present invention can provide a Report construction (or just, “Report”) wherein heat transfer related data, such as 3D viewpoints, building characteristic data and products can be integrated with jobsite-related field data from onsite crews associated with a relevant supplier/party/stakeholder. Products may include deliverables of fixtures, furnishings and equipment, while building characteristic data may include products, labor, material and an associated resolution of a respective selection, or a portion thereof, as defined per each relevant supplier in heat transfer. The associated resolution may define the other components of the building characteristic data. Field data may integrate site orientation data, weather data, and GPS data with building characteristic data through a design construction, whereby each product can be located in physical space and selection in a sequential relationship relative to other associated or grouped products. The weather data can be incorporated in the design and other time-related delivery predictions.

The Report can be configured to interlink the above-mentioned building characteristic data generated through heat transfer to field data and construction data. Field data may include information collected onsite at the relevant building(s). Field data can be gathered at the jobsite via suppliers by way of daily field reports in the form of progress video output, captured images, audio output of recordings, documentation related to the location and progress issues for each building characteristic data and associated resolution

In other words, Report is a construction management tool for interlinking the field-based progress data of a building with the virtual heat transfer-model building characteristic data, as well as integrating construction data to facilitate each associated resolution. The Report can be configured to interlink to heat transfer building characteristic data and thus heat transfer models, thereby providing field crews selective access to building characteristic and field data for each associated resolution. In contrast, the prior art requires reviewing of large amounts of documents that might be outdated and/or irrelevant.

The Report can be configured to interlink building characteristic data to a design construction. Building characteristic data may include products, materials, labor, etc. embodied in a selection defined in heat transfer, and the associated resolution thereof. Through the design construction, progress relevant to the associated resolution can be tracked, managed, analyzed, and predicted. For example, progress in the field (in the form of field data) can be analyzed against the design construction-enabling notification to assigned supplier—e.g., suppliers in managing their work. The design construction may include GPS data, weather data, and calendar data for facilitating design tracking of selections and associated resolutions. The Report can be configured to interlink building characteristic data and field data to a progression construction, where installation of products (and utilization of materials and labor) can be tracked, through delivery of the products to progress reports embodied in suppliers' documentation until associated resolution up and through to an associated resolution. A lack of progress or status reports being indicative of an absence of the associated resolution. Specifically, Report can be configured to provide notification when selections are within a predetermined variance and/or when deliverables are running behind the selection time. Through such modalities, material, objects, and variation products can track effect of selections, and so inefficiencies, heat transfer changes and the like can be determined.

The Report can be configured to provide an activity management module. Through the activity management module, users can edit activities. Such activity edits may include the collection and integration of onsite field data. Field data may include online real time characteristic definitions files related to heat transfer building characteristic data and non-heat transfer building characteristic data. Such electronic files can be captured images of the products, objects and location in relation to selection activities. They may also be recorded information from the onsite crew of the relevant suppliers and/or a resolution between various associated suppliers, for example, the recording of a go-to-resolution presentation regarding the status. The files may also be documents regarding change orders and redesigns relevant to a specific object or product.

As stated above, all the heat transfer rating and product information can be integrated in the underlying heat transfer data or non-heat transfer data for a given building characteristic, whereby the stakeholders can facilitate focused issue and alert management, and thus manage and deliver a completed building characteristic in a more efficient manner through heat transfer.

Through the Report disclosed above, the field data can be integrated with heat transfer data, non-heat transfer data such as documents, resolution data and selection activity modules to facilitate the efficient delivery of a heat transfer managed and field building characteristic management.

With refence to FIG. 19, the heat transfer system can help visualize the problems of building in real time with real people. Quick heat transfer data access, relevant heat transfer data access in timely fashion and integration of heat transfer data with field data is extremely crucial for success of the building characteristic. Time and time again, a good heat transfer models or data due to lack of access creates field issues defeating the purpose of early planning. Frequently, field variations from virtual models create for unforeseen issues delaying the building characteristic and impacting building subset.

The report 70 is a system, tool and method that mainly focus on bringing this gap between virtual data and field data by integrating the two and provide analytics that helps improve progress by providing quick and relevant data to field and more importantly creating analytic by comparing the two data points identifying the issues proactively and helping managers solve them before they become an issue.

### Overview of Application and System

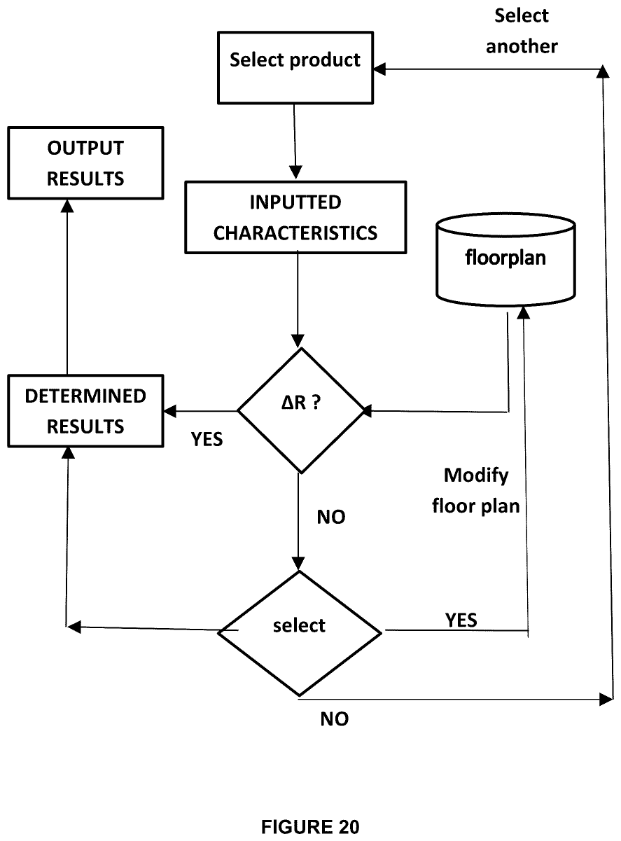

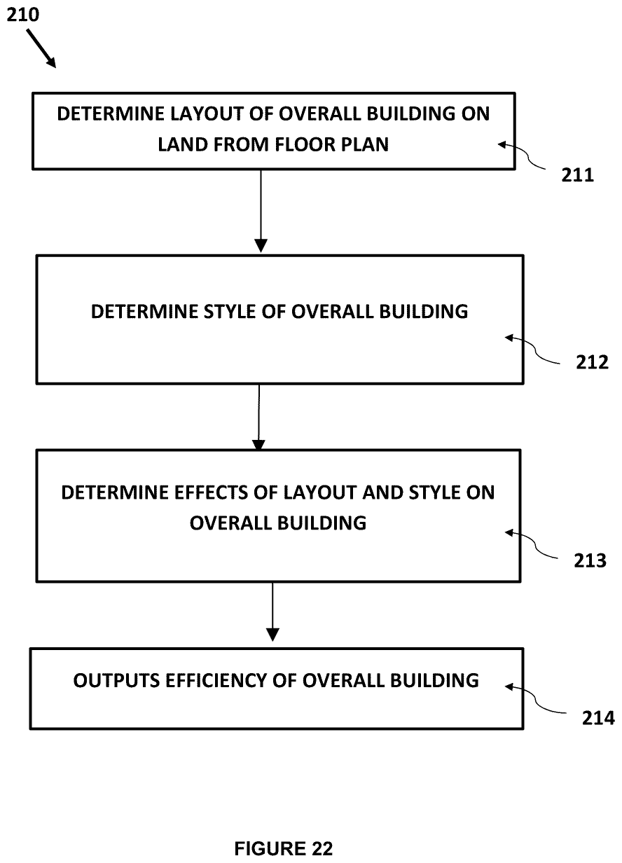

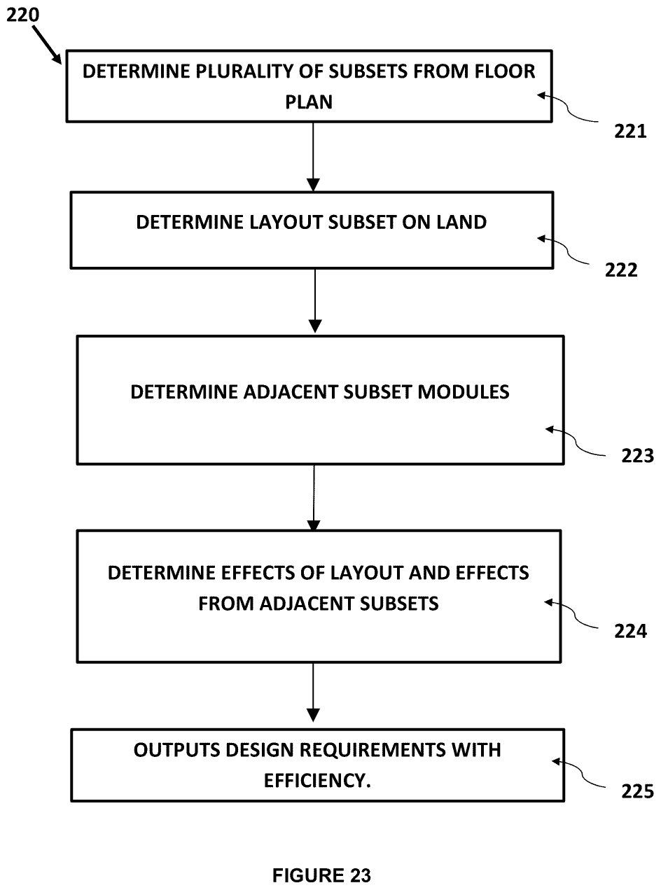

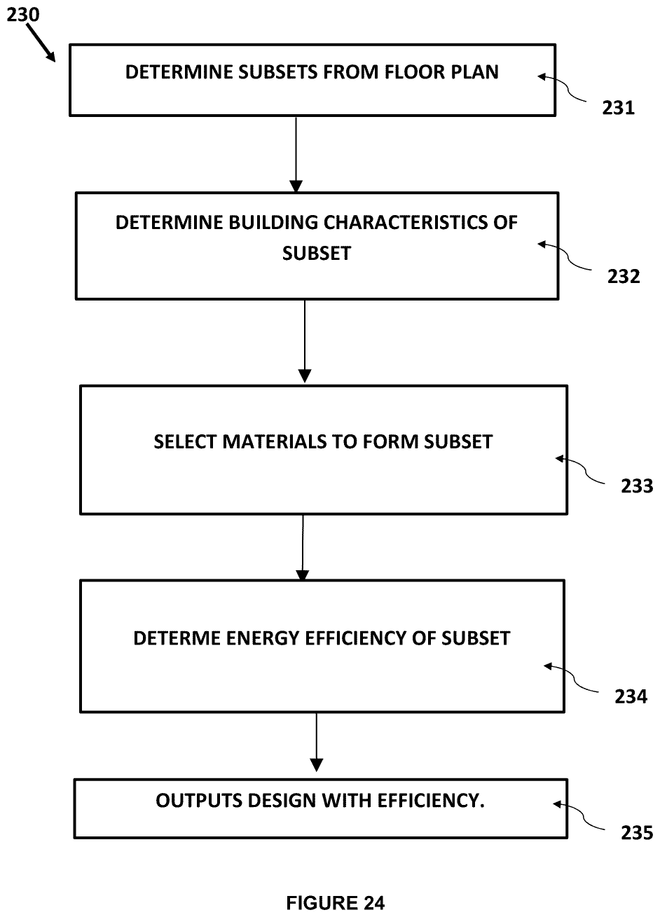

With reference to FIGS. 20 to 24 there is shown overall operation 200 which includes step 201 of obtaining overall building review from outline of a floor plan developed by architect or designer. In step 202 it is determined the effect on overall building. This is achieved in step 203 by determining subsets of building from floor plan and in step 204 determine energy efficiency of each subset and in step 205 determine the overall building by rebuilding from plurality of subsets.

In operation 210 the effect of the design of building, there is initial step 211 of determining the layout of the overall building from the floor plan. In step 212 there is determined a style of the overall building. This can be whether it is weatherboard, brick and whether it includes verandah shading the building or eaves or straight faced walls or other architectural effects that has an effect on the heat transfer of the building. Those effects of layout and style on the overall building are determined in step 213 and in step 214 how they affect the overall building.

In operation 220 there is the important element of the effect of layout of the building on the building site and the orientation to North with resultant sun effects and with other weather effects such as usual breeze direction and rain direction. After determining the subsets in step 221 there is determined the layout in step 222 and finalization of the best orientation for weather, building and heat transfer reasons. The effect on one subset is then assessed in step 223 as to the effect on adjacent subsets so that in step 224 the effects of the layout are determined for the adjacent subsets and allows overall design to be assessed in step 225.

In operation 230 there is the effect of choice of materials. Following step 231 of determining the subsets, there is in step 232 of determining building characteristic and in step 233 of selecting material to form the subset. However in step 234 the energy efficiency of the subset is determined and by step 235 outputs design with the selection and with the resultant energy efficiency. In this way the building structure is modified in real time and construction proceeds in real time with required real time decisions.

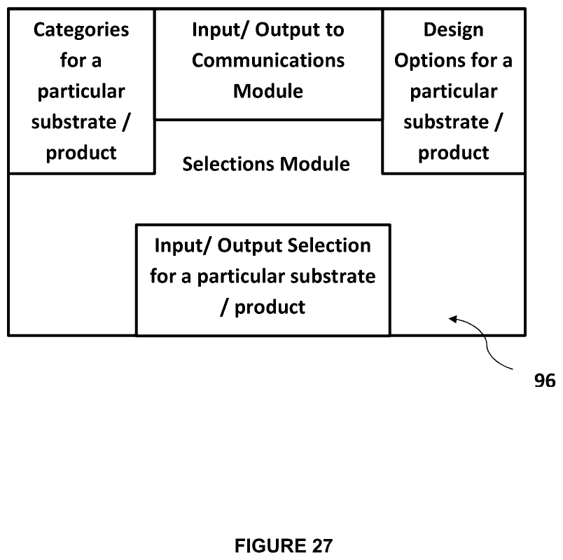

With reference to FIGS. 25 to 28 there is shown the modules forming the framework of the building system and the design and assessment of building characteristics values. This can include a building system enabling efficient construction of a building including a modelling module 90 which is provided for receiving a design of a building and defining a model of the building. Therefore the architect can design the building in general and undertake the essential engineering and expected general aesthetic approach. This becomes the blueprint for the builder but is not a precise how-to document. There will be many selections of materials and many changes or fine tuning of construction as the building progresses not only for aesthetic choices but also for building issues not considered, product or expertise supply issues, and a range of other considerations that occur in complex systems.

However for this to be able to be considered in real time it is necessary to define and review the subsets of the whole design.

The system provides a defragmentation module 91 which dissects the building design into building subsets 30 to 35 with building substrates 22, 24. This is an important element in that each subset is comprised of various substrates and the defragmentation module allows the separate subset to be reviewed as in FIG. 4 while also understanding and considering the interaction of modules by their relative location and common substrate as shown in FIG. 5.

A building location module 92 which receives input of building location characteristics and reviews building subsets and combination of interactive subsets 46 and determines the impact of heat transfer on building subsets 30 to 35 forming the combination 46. Those building subsets include the slope of the building site, the orientation according to compass direction and weather characteristics such as the height and pathway of the sun in various seasons. Thereby with the identification of shading elements such as trees, fences, topology, or parts of the building, the effect of the weather conditions on the building can be determined.

The system includes a building characteristic module 93 including building characteristic assessment including heat transfer, moisture, value, which reviews building substrates 22, 24 of each subset 30 to 35 to assess building design, building material and building location characteristics of building subsets to calculate heat transfer of each building subset.

A reconfiguration module 94 reconfigures the building subsets 30 to 35 to reconfigure the model of the building and determine the effect of heat transfer of one subset on another to determine heat transfer of the entire building.

A communications module provides for cotemporaneous communication connection to a plurality of product suppliers at the time of review to obtain in real time the heat transfer of a product forming a building substrate.

The communications module 95 includes direct real time connections to various suppliers 111, 112, 113, 114. The suppliers can be different for different substrates and different subsets and relative positions such as next to the garage or facing the rear garden or between bathroom and bedroom. These are controlled by the communications module and different real time connections to the different suppliers for a particular substrate r product is provided. This means that instead of a builder needing to collect or collate a range of 4 to 6 suppliers for a range of 20 to 30 different substrates and then review them consistently before selection is undertaken the present system allows the options to be provided and direct communication occur. This is particularly relevant if stock at first supplier 111 shows that selection A is nor available but option B is available and the building characteristics are immediately available of option B such that the effect on the building subset and the effect on the whole of the building can be assessed in real time and the building progress with option B if it is a wanted option and provides the required practical result.

It can be seen that this direct linkage provides a substantial advantage and transforms the heat transfer aspect of building from being a dry review after the event of construction of building has occurred to an active tool in undertaking the construction of the building.

A selection module 96 provides a selection of building products to be used to form building substrates and receives input of selection of a product from a connected source of a range of products for a defragmented building substrate.

The selections module needs to interact with the communications module 95 for cotemporaneous communication connection to the plurality of product suppliers at the time of selection to obtain in real time the heat transfer of a product forming a building substrate 22, 24.

### Purpose:

a) to gain knowledge and accuracy of the value of your home at early stage of designing.
b) Moisture affects the thermal performance (R-value) of a material. The R-value drops because water displaces the insulating air that is trapped in insulation.
c) This system will enable to apply materials to a part(s) of a structure to gain a better understanding of the impacts of the material generated and built into the software. This will enable the material to have the affects built by its composite form, the same as being manufactured, to reflect real-world building conditions.

### Who Can Use it:

Architects, Draftsman, Builders, 3D Renderers, Town Planners, Energy raters: All information can be located onto the one system with different profession usage.

A soil report can impact the house. Soil report is crucial as it determines your soil classification and what materials are recommended for example concrete slab. The concrete slab can have effects on the building with it's thickness, it's composite

An example of altering impact is resultant of the date, time, day/night of the location, and therefore these factors are needed to obtain how much heating is required/used during summer and winter.

Other factors that influence impact are the selection of building materials: type of structure, type of design, performance requirements, cost, climate, building materials availability, aesthetic reasons, environmental reasons/impacts, thermal performance, moisture, insulation, fire resistance, materials ingredients etc

R-value—R-value is the measurement of a material's capacity to resist heat flow from one side to the other. A higher number represents more effective insulation.

Thermal mass properties, the composite and thickness of the material, the method of design and construction will change the R-Value of the building.

Information that impacts the design and costs. Relationships between materials when building can be the difference. Materials when building have complex relationships—Carpets, tiles, paints, windows and internal and external coverings when combined in a new or renovated home have complex ratings and impacts. It affects price, environment and design. Consumers do not get simple choices with visual designs.

### The Problem Includes:

a) Materials: Building material properties have relationships to the building, there is complex temperature ratings, environmental impacts, cost to build and how they look and feel together
b) Complex: When 2 or more materials meet, cost and environmental aspects change. This is complex and makes material selection important
c) Calculate: Calculations now needs expert people to do complex calculations and 3d renders to determine how materials interact. This adds to the building permits and energy ratings.
d) Simplicity: No simple way for a home owner to change materials online and see the impacts on price, energy ratings or utility costs.
e) Suppliers/builders: Because this process is difficult and complex, consumers cannot easily select preferred materials without a long complicated and costly process.

The solution includes a new approach to building with use of simple to use online tool with 3d render engine so that new materials and the impact on cost and environmental impacts can be seen in a few clicks by low skilled consumers.

### This Uses:

a) Entering of data: Enter dimensions and current building data by architect/builder—send materials selector to consumer
b) Choosing materials, structures, construction: Choose, floor wall, ceiling, roof and other fittings and see in real time their impact and cost
c) Calculating effects before or during building: See star ratings, build material cost in real time. Empowering the consumer for a better-informed choice.

### Example

The products of CSR Australia can be included in an online product module in the form of FIG. 10:

| Product | Thickness | R-Value |
|---|---|---|
| Hebel PowerPanel | 75 mm Hebel Panel | R = 0.52 |
| Brick | 110 mm | R = 0.18 |
| Fibre Cement | 6 mm | R = 0.03 |

See https://www.csr.com.au/building-knowledge/building-science/what-r-values-mean-in-home-building-decisions

### Measuring the R-Value of Building Materials

How well a building material withstands heat moving through it is measured in terms of thermal resistance, referred to as ‘R-value’. The greater the resistance to heat flow, the higher the R-value. It is calculated on the thickness and bulk density (kg/m3) of the material and the rate at which it conducts heat. The greater the bulk density of a material, the lower its thermal resistance. Materials that are poor conductors of heat are better insulators because heat moves through them more slowly.

The table above is showing the R-values of Brick, Hebel PowerPanel and Fibre cement.

Even though a standard 110 mm brick is thicker than the 75 mm Hebel PowerPanel panel, brick has poorer thermal resistance due to its greater bulk density compared to the Hebel. This indicates the role of thermal conductivity or the transfer of heat through a material and is influenced by different factors including its microstructure, composition, bulk density and size and structure of pores.

### R-Value and Total R-Value

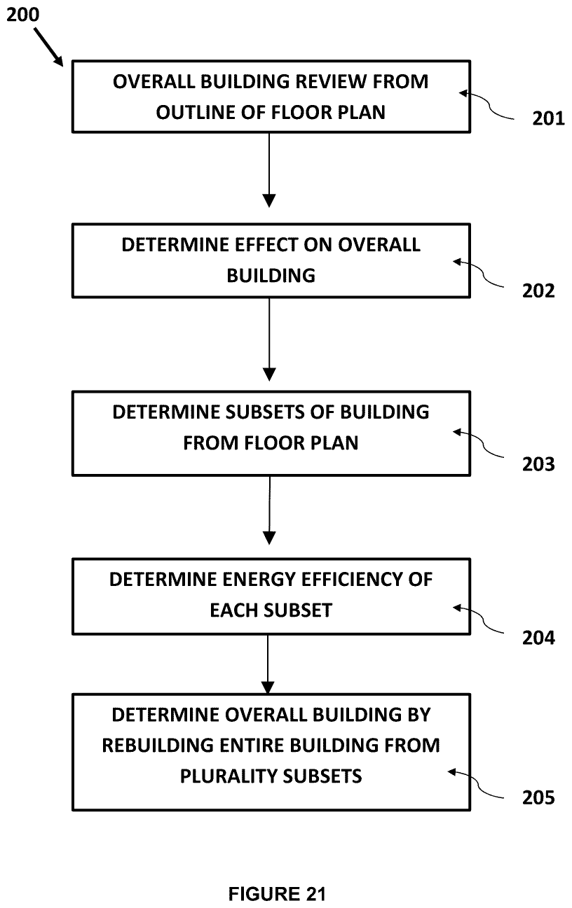

A Total R-Value is the sum of the R-values of the individual components within a structure, for example a brick veneer wall. The Total R-Value includes any building materials, insulation materials, airspaces and internal/external air film surfaces.
R-VALUE—the thermal resistance of a material calculated by dividing the thickness by its thermal conductivity. R-Value=Thickness (m)/Thermal conductivity (W/mK)
TOTAL R-VALUE—are based on the sum of all components of the building system including building materials, air space, insulation
By integration of such information into online product module it can be incorporated into the system by the interconnection of modules of FIG. 21.

### Example

Windows/Doors have the Window Energy Rating Scheme (WERS). An example how different manufacturers have different U-Values/SHGC and how they impact the overall ratings.

| Window | | | | | |
|---|---|---|---|---|---|
| ID | Manufacturer | Frame | Glazing | U-Value | SHGC |
| AWS-001- | Architectural | Residential Series | 5clr | 6.4 | 0.72 |
| 02 | Window | 502/504 Sliding | | | |
| | Systems | Window- Single | | | |
| | | Glazed | | | |
| AWS-001- | Architectural | Residential Series | 6.38CP | 4.6 | 0.44 |
| 05 | Window | 502/504 Sliding | | | |
| | Systems | Window- Single | | | |
| | | Glazed | | | |
| A&L-001- | A&L Windows- | A&L Aluminium | 4Clr | 5.9 | 0.64 |
| 04 | VIC | Awning - Single | | | |
| | | Glazed - with In- | | | |
| | | Line Reveal | | | |
| A&L-004 | A&L Windows- | A&L Aluminium | 3Clr/12/3Clr | 3.5 | 0.55 |
| 01 | VIC | Awning Window - | | | |
| | | Double Glazed - | | | |
| | | with In-Line Reveal | | | |
| AWS-011- | Architectural | Residential Series | 5Clr | 6.2 | 0.72 |
| 01 | Window | 541/542 Sliding | | | |
| | Systems | Door -Single | | | |
| | | glazed | | | |
| AWS-013 | Architectural | Residential Series | 4Clr/10/4Clr | 4.0 | 0.61 |
| 01 | Window | 541/542 Sliding | | | |
| | Systems | Door -Double | | | |
| | | Glazed | | | |
| DOW-001- | Dowell | Aluminium Sliding | 3Clr | 6.5 | 0.75 |
| 01 | | Window - Single | | | |
| | | Glazed | | | |
| DOW-005 | Dowell | Manor Awning | 3Clr/12/3 | 3.9 | 0.58 |
| 01 | | Window - Double | | | |
| | | Glazed | | | |

U-VALUE—The typical U-Values on windows is a measurement of heat loss and the rate at which it is lost. U-Values indicate the overall performance in retaining heat and preventing it from escaping to the outside. U-Values are measure in Watts per square metre Kelvin, or W/m2 K.

SHGC—Solar Heat Gain Coefficient (SHGC) is the measure of the percentage of solar heat gain that passes through a window. . . . The other element to rating a window based on the frame and glass is known as the U-Value. A U-Value is the measure of how much heat energy is transferred through a window.

Solar Heat Gain Coefficient or SHGC is a measure of how much solar radiation passes through the window. In a cool climate, windows which have a high SHGC allow a greater amount of solar radiation to pass through, offering free solar heating for the home.

Builders and designers have access to commence at early stages. Builders and designers can add/nominate their own suppliers through the software link. Builders have a calculator to show clients costs. Soil report, developers % render recommended, site plan, overlooking, overshadowing, energy rating can help town planning drawings have an accurate reading. The more information applied the more accurate the reading from the drawings even at concept or town planning stage.

| System Application | Acoustic | Thermal | Thickness |
|---|---|---|---|
| PowerPattern ® | Rw + Ctr 45 to | R2.06 to R3.22 | 179 mm to |
| external wall system | 48 based on a | | 210 mm |
| | 210 mm wall | | |
| | system thickness | | |
| PowerPanelXL | Rw + Ctr 35 to | R1.61 to R3.57 | 179 mm to |
| external wall system | 39 | | 210 mm |
| PowerBlock + | Rw + Ctr 35 to | R2.04 to R4.19 | 250 mm to |
| external wall system | 42 | | 356 mm |

See https://hebel.com.au/segment/houses/?application=external-walls#segment-applications

### What-if

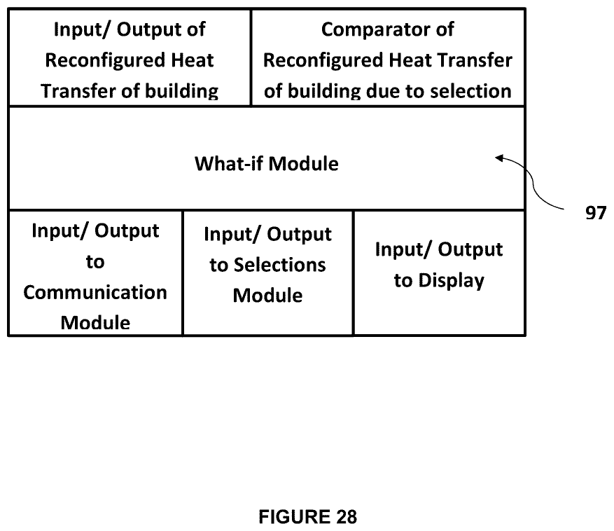

Referring to FIGS. 28 to 30, the building heat transfer system includes a what-if comparator module 97 which receives the heat transfer of the entire building, records the model reconfiguration of building subsets, tracks the selected selections and the received contemporaneous heat transfer of the building subsets, and records the reconfiguration of building subsets resulting from selection and displays the effect of the selected selection over the model to show the effect of the selection to enable efficient construction of energy efficient heat transfer of entire building. This can be in report 70.

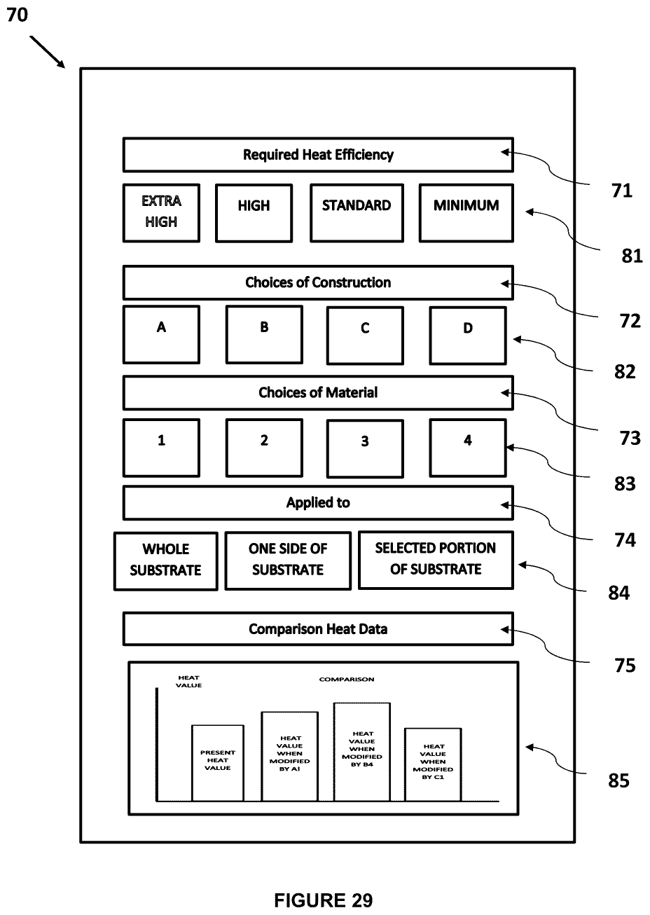

In FIG. 29 the selection of the required heat efficiency is an option 71 for the user or builder to achieve. If initially it has been determined that a high efficiency rather than an extra high is required then the correct selection 81 can be instigated.

The next selective option shown is the choices of construction in option 72. There can be a selective aesthetic option in options 82 of A, B, C or D which could be wood or brick or stone or cement sheeting. This choice could be optional in that the choices whether you like the effects of wood or stone or whether for costs the cement sheeting is selected. However, it no longer remains an option when this result needs to coordinate with the selection of the required heat efficiency. If cement sheeting or even stone are not going to provide the required heat efficiency, then the immediate inline in real time feedback will identify the effects to the heat transfer and how that selection is not possible to achieve the aim. In this way correct procedures and selections are being created while the building is being constructed and not after the event.

The next choices can be the particular materials 73 that can be solid wood or brick façade or weatherboards. Clearly in different substrates of different subsets then different options 1, 2, 3 or 4 will apply. The substrate of the wall onto the garage is a different selection to the wall facing out to the rear garden or to the heat surface of the fireplace or kitchen wall or to the plumbing wall of the bathrooms. Again although the option might start as an aesthetic choice the system immediately and in real time transforms the selection into a practical element that is required to be selected to provide the required local heat transfer effects such as stopping dispersion of heat from kitchen oven to enhancing transfer of heat from a heating source such as a heater or fireplace etc. Further having an aesthetic choice of windows facing outwardly to the garden becomes transformed into a building variation required in order to maintain the required heat transfer rate by not allowing all of the heat to be lost to through the windows or not all of the direct sunlight heat being transferred into the building.

However, the system not only looks at the material of a whole substrate but as with the complex substrate 24 of FIG. 2 there can be a selection 74 of whether applied to any options 84 whole substrate, one side of substrate or selected portion of substrate. This is particularly the concern of windows or glass doors. The choice might be a wide view of glass out to the backyard but unless the windows or doors are double or triple glazed the required heat efficiency is not a practical choice unless only 50% of the substrate is glass.

Overall therefore the selections result in a comparison heat data 75 that visually indicates the effects of the choices and the variations from the initial design so that the required heat value is maintained and in real time the selection of building. material, building design or complex building substrate is undertaken to construct the building.

The what-if comparator needs to compare the provide building characteristic data relating to the building modelling system, wherein building characteristic data is associated with resolution of a selection of the building modelling system. It also provides a heat transfer rating configured to a first product for both a delivery of the building characteristic data and a second product for an associated resolution to the building characteristic data; and provides a comparative heat transfer rating configured to link product and design selection data from the building to the building characteristic data.

It is in this way that in real time a builder or owner can make selections of variations a plurality of building characteristics of
a) Building material characteristic category;
b) Building design characteristic category; and
c) Building orientation.

The plurality of building characteristics from categories selected from:
a) structure;
b) material;
c) insulation;
d) thickness;
e) layering;
f) openings; and
g) location.

The building characteristic can be an assessed value which is one or more of:
a. Heat transfer R
b. Moisture content M
c. Value V
d. Environment E
e. Soil S
f. Daylight D.

The assessed value of the building characteristic can take into account one or more of:
The material
The quantity or thickness of the material
The composite components
The complex structure such as prefabricated wall panels with window
The method of how to be used in building construction
The juxtaposition of other products, building components or environment.

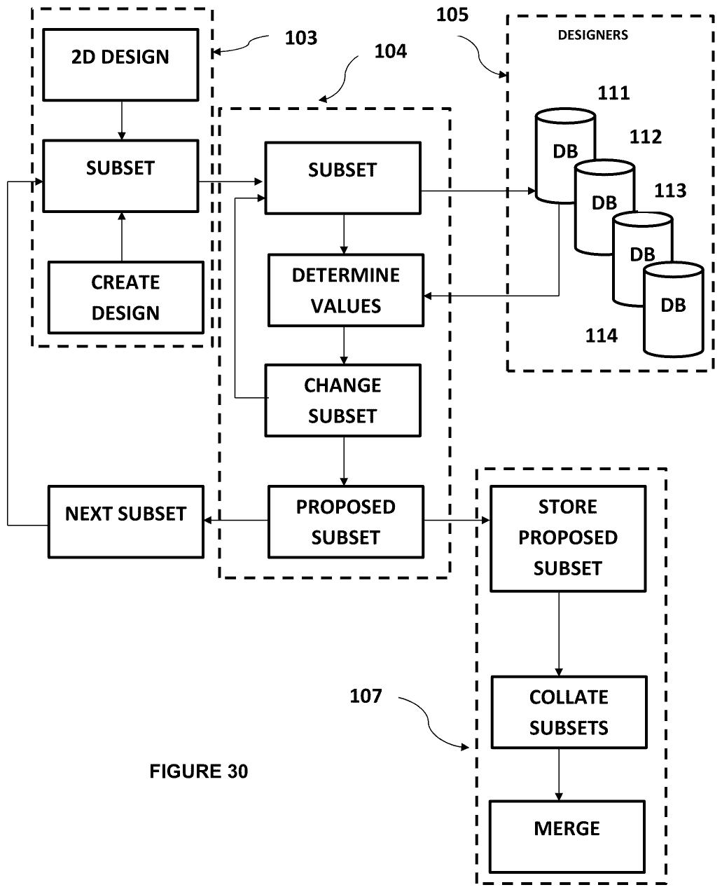

As per FIG. 30 the first stage is the setup 103 of the design of the building model by use of a 2D design converted to 3D design or initially in 3D design and then defragmented into building subsets. Each subset progresses assessment including material selection or component from connection to online product suppliers 105 that can individually provide an online product module 52 for use in determining building characteristic values of that subset and by iterative progression for each subset the reconfiguration 107 of the subsets values can be merged and interrelated to provide the assessment of the entire building so as to allow the use of the materials in the defined manner provide the defined building with the assessed building characteristic values.

Therefore the invention provides for a method for improving a building modelling system for a building, comprising coupling a product selection functionality to the building modelling system; the product selection functionality configured to: obtain virtual building characteristic data relating to the building modelling system, wherein building characteristic data is associated with resolution of a selection of the building modelling system, and wherein building characteristic data includes at least one product required for the associated resolution, wherein each product comprises usage data and location data, wherein usage and location data is defined by the building modelling system; provide a heat transfer rating configured to a first product for both a delivery of the building characteristic data and a second product for an associated resolution to the building characteristic data, wherein field data comprises direct links in real time to data on the first or second product; and provide a comparative heat transfer rating configured to link field data from a the building to the building characteristic data; and providing a resolution functionality configured to generate resolved selected construction data linked to the selected first or second product.

This and other uses and benefits of the invention can be understood and are included within the scope of the invention.

### INTERPRETATION

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics can be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention can be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications can be made thereto without departing from the spirit of the invention, and it is intended to claim all such changes and modifications as fall within the scope of the invention. For example, any flowpaths given above are merely representative of procedures that can be used. Functionality can be added or deleted from the block diagrams and operations can be interchanged among functional blocks. Steps can be added or deleted to methods described within the scope of the present invention.

The computer-based data processing system and method described above is for purposes of example only, and can be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system relevant to the invention are described, and standard building details well known in the art are omitted.

For the same reason, the computer hardware is not described in further detail. It should thus be understood that the invention is not limited to any specific computer language, program, or computer. It is further contemplated that the present invention can be run on a stand-alone computer system, or can be run from a server computer system that can be accessed by a plurality of client computer systems interconnected over an intranet network, or that is accessible to clients over the Internet.

In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention.

Further, to the extent the present application discloses a method, a system of apparatuses configured to implement the method are within the scope of the present invention.

It should be understood, of course, that the foregoing relates to exemplary embodiments of the invention and that modifications can be made without departing from the spirit and scope of the present invention.

Although the invention has been described with reference to specific examples, it will be appreciated by those skilled in the art that the invention can be embodied in many other forms.

### INDUSTRIAL APPLICABILITY

It is apparent from the above, that the arrangements described are applicable to the building and energy efficiency industries.

1-30. (canceled)

31. A building system enabling efficient construction of a building, comprising: a. a modelling module for receiving a design of a building and defining a model of the building; b. a defragmentation module which dissects the building design into building subsets with building substrates; c. a building location module which receives input of building location characteristics and reviews building subsets and determines the impact of a building characteristic on building subsets; d. a heat transfer module which reviews building substrates, building design and building location characteristics of building subsets to calculate building characteristic of each building subset; and e. a reconfiguration module which reconfigures the building subsets to reconfigure the model of the building and determines the effect of building characteristic of one subset on another to determine building characteristic of the entire building.

32. The building system according to claim 31, wherein the building characteristic is one or more of:
a. Heat transfer R; b. Moisture content M; c. Value V; d. Environment E; e. Soil S; amd f. Daylight D.

33. The building system according to claim 31, further comprising f. a communications module for cotemporaneous communication connection to a plurality of product suppliers at the time of review to obtain in real time the heat transfer of a product forming a building substrate.

34. The building system according to claim 31, further comprising: g. a selection module which provides a selection of building products to be used to form building substrates and receives input of selection of a product from a connected source of a range of products for a defragmented building substrate; and h. a communications module for cotemporaneous communication connection to the plurality of product suppliers at the time of selection to obtain in real time the heat transfer of a product forming a building substrate

35. The building system according to claim 34, wherein the selection module and communication module effect the transmission of an online building product module having details including one or more building characteristics of a building product for use on a building subset.

36. The building system according to claim 35, wherein the method of data gathering is the use of an online product module includes at least one one of: a. downloadable online product module from online site of supplier a formatted and inclusive of latest up to date information including material, building material and building construction values; b. connecting module attachable to the websites of the online site of supplier that is bespoke to each of the suppliers to create a respective online product module for download to the communication module for providing the information for use in the building characteristic assessment module; and c. connecting to the websites of the online sites of suppliers and downloading information which is transformed to create an online product module for download to the communication module for providing the information for use in the building characteristic assessment module

37. The building system according to claim 31, further comprising a. a what-if comparator module which receives the heat transfer of the entire building; b. records the model reconfiguration of building subsets; c. tracks the selected selections and the received contemporaneous heat transfer; and d. records the reconfiguration of building subsets resulting from selection e. displays the effect of the selected selection over the model to show the effect of the selection to enable efficient construction of energy efficient heat transfer of entire building.

38. A building system, comprising: a. an access port for upload to an online computerised means adapted for following computerised instructions according to a freeform definition and controlling of a building heat transfer system; b. at least one input device for allowing a user to select a user particular input including i. a base design for adaption; ii. a selection of variation of a material characteristic to form a modified design c. at least one display device for allowing display of an output to the user with a defined efficiency of the base design and/or the modified design; d. at least one database including i. building materials with defined building material characteristics for selection of a material characteristic in a user particular input; and ii. building design variation with defined building material characteristics for selection of a design characteristic in a particular user particular input; and e. at least one receiver for transmitting for receiving by at least one of the at least one display device for allowing display of the respective confirmed user defined building heat transfer system; wherein the plurality of user particular inputs defines the freeform definition and control of a building heat transfer system and the selection of an efficient building characteristic defines the final output and is provided to the at least one display device.

39. The building system according to claim 38, wherein the predefined input framework identifying a plurality of building characteristics includes a plurality of categories for selection of at least one building characteristic in at least each of the plurality of categories by the user in their respective user particular input.

40. The building heat transfer system according to claim 39, wherein the categories of building characteristics include: a. a building material characteristic category; b. a building design characteristic category; and c. a building orientation.

41. The building system according to claim 40, wherein the predefined input framework identifying a plurality of building characteristics includes a plurality of categories comprising: a. structure; b. material; c. insulation; d. thickness; e. layering; f. openings; and g. location.

42. A method of automatically designing and assessing a building system using a computerised system comprising the steps of: a. providing a predefined input framework identifying a plurality of building characteristics for selection by the user in their respective user particular input b. defragmentation of a building design into subsets and undertaking assessment of the individual subset c. providing a plurality of categories for defining at least one selection must be made in each category; d. providing a plurality of building characteristics each allocated to one only of the plurality of categories; e. receiving the user defined building heat transfer system application from each of a plurality of users over a digital communication system connected to an access port for upload to an online computerised means adapted for following computerised instructions according to a freeform definition and control of the building heat transfer system; f. selecting an energy efficient building characteristic from each category; g. comparing the plurality of energy efficient building characteristics from each category to each of confirmed product supplier wherein a selection of an efficient building characteristic from each category defines the required design; h. determining the relative effect of one subset on adjacent subset; and i. providing a whole effect on the reconfigured building design.

43. The method according to claim 42, wherein the predefined input framework identifying a plurality of building characteristics of: a. a building material characteristic category; b. a building design characteristic category; and c. a building orientation.

44. The method according to claim 43, wherein the input framework identifying a plurality of building characteristics from categories comprising: a. structure; b. material; c. insulation; d. thickness; e. layering; f. openings; and g. location.

45. The building system according to claim 44, wherein the building characteristic is one or more of: a. heat transfer R; b. moisture content M; c. value V; d. environment E; e. soil S; and f. Daylight D.

46. An apparatus for optimizing building system building efficiency and real-time characteristic performance of a building system, the building system comprising a building sub-set system having a plurality of building sub-sets and one or more building characteristics for controlling heat efficiency into the plurality of building sub-sets, the apparatus comprising: a. a system controller coupled to the one or more building materials; and b. said system controller comprising a processor and a non-transitory memory storing instructions executable on the processor to perform steps comprising: i. acquiring one or more operational parameters associated with the building system; ii. selectively controlling the one or more building characteristics based on the one or more operational parameters such that that heat transfer is of selected building sub-sets of the building and not through the entire building; and iii. maintaining one or more of design, construction, and selected product for each building substrate in each building sub-set in which heat efficiency is optimised by system efficiency of the plurality of building sub-sets of the building.

47. The apparatus of claim 46, wherein the one or more operational parameters comprises one or more readings from virtual sensors located within the building system and coupled to the controller.

48. The apparatus of claim 47, wherein the temperature efficiency is determined as a function of one or more of measured temperatures from sensors or virtual sensors located in the one or more building subsets, a predicted building subset-zone temperature, or a building subset R-value.

49. The apparatus of claim 48, wherein the capacity of two or more zones is selected from the group consisting of: a. an internal building subset; b. a peripheral building subset; c. a window, door or opening building subset; and d. a roofing building subset.

50. A method for improving a building modelling system for a building including coupling a product selection functionality to the building modelling system; a. the product selection functionality adapted to: i. provide building characteristic data relating to the building modelling system, wherein building characteristic data is associated with resolution of a selection of the building modelling system; ii. provide a heat transfer rating configured to a first product for both a delivery of the building characteristic data and a second product for an associated resolution to the building characteristic data; and iii. provide a comparative heat transfer rating configured to link product and design selection data from the building to the building characteristic data.

51. A method for improving a building modelling system for a building includes coupling a product selection functionality to the building modelling system; the product selection functionality adapted to: a. obtain building characteristic data relating to the building modelling system, wherein building characteristic data is associated with resolution of a selection of the building modelling system, and wherein building characteristic data includes at least one product required for the associated resolution, wherein each product comprises fitting data and location data, wherein fitting and location data is defined by the building modelling system; b. provide a heat transfer rating configured to a first product for both a delivery of the building characteristic data and a second product for an associated resolution to the building characteristic data, wherein field data comprises video, audio and textual output linked to the first or second product; and c. provide a comparative heat transfer rating configured to link field data from a jobsite of the building to the building characteristic data; and d. a resolution functionality configured to generate construction data linked to the first or second product, wherein construction data comprises video or audio output from the jobsite.
